(19) United States
(12) Patent Application Publication
(10) Pub. No.: US 2011/0111080 A1
(43) Pub. Date: May 12, 2011

(54) Mold Structure For Injection Molding

(76) Inventors: Xian Yun Wang, Taipei (TW); Xiaoping Wu, Taipei (TW); Shih-Hsiung Ho, Taipei (TW)

(21) Appl. No.: 12/614,396

(22) Filed: Nov. 7, 2009

(51) Int. Cl. B29C 45/28

(52) U.S. Cl. 425/542

(57) ABSTRACT

A mold structure has a first die, and a second die. A first buckling element is protruded downwardly from the first die, and defines a first contact surface and a bottom surface. The bottom surface has an end adjacent to the first contact surface protruded downwards to form a jamming portion, and the other end protruded downwards to form a blocking portion spaced away from and beyond the jamming portion. The jamming portion has a triangle cross-section, with a point facing downwardly and away from the blocking portion. A second buckling element is extended upwards from the second die, and has a gap at a top end thereof and passing through a side thereof. The gap defines a second contact surface, corresponding to the first contact surface, and an inclining surface, intersecting with the second contact surface with an acute angle formed therebetween for engaging with the jamming portion.

### BACKGROUND OF THE INVENTION

1. Field of the Invention

The present invention relates to a mold structure, and particularly to a mold structure for injection molding.

2. The Related Art

More and more electronic devices are designed and used in the daily life, especially the portable electronic devices. The portable electronic devices, which have multiple functions, miniature configuration and high quality, are more and more popular with consumers. At present, most components of the portable electronic devices are manufactured by the injection molding for increasing efficiency and reducing cost. FIGS. 1-4 are cross-sectional views showing a mold structure for the injection molding. The mold structure includes a first die (not shown), and a second die (not shown) disposed under and coupled with the first die. The first die has a first main body (not shown). The first main body has a protrusion 11′. A bottom of the protrusion 11′ is extended downwardly to form a first buckling element 12′. The first buckling element 12′ defines a first contact surface 13′ extending upwards and downwards, a bottom surface 14′ perpendicular to the first contact surface 13′. A portion of the bottom surface 14′ away from the first contact surface 13′ is extended downwards to form a blocking portion 15′. The second die has a second main body (not shown). The second main body has a second buckling element 21′. The second buckling element 21′ has a gap 22′ at a top end thereof and passing through a side thereof, with a second contact surface 23′ defined thereon. When the first die is engaged with the second die, the first buckling element 12′ is buckled with the gap 22′ of the second buckling element 21′. The blocking portion 15′ is spaced from the second buckling element 21′ for receiving the injection material therebetween. The first contact surface 13′ rests against the second contact surface 23′ tightly for preventing the injection material from flowing outside the mold.

However, as the first die and the second die, used for molding the components of the portable electronic devices, are usually small and thin, and have weak strength, the pressure force from injecting material between the second buckling element 21′ and the blocking portion 15′, is apt to separate the first die from the second die so as to form an interval 3′ between the first contact surface 13′ and the second contact surface 23′. As a result, the component molded by the first die and the second die has a burr formed in the interval 3′, reducing the precision thereof and the quality of the portable electronic device.

### SUMMARY OF THE INVENTION

Accordingly, an object of the present invention is to provide a mold structure for injection molding which is capable of improving the precision of the molded components. The mold structure for injection molding has a first die, and a second die disposed under and holding the first die. A first buckling element is protruded downwardly from the first die. The first buckling element defines a first contact surface extending upwards and downwards, and a bottom surface perpendicular to the first contact surface. The bottom surface has an end adjacent to the first contact surface protruded downwards to form a jamming portion, and the other end protruded downwards to form a blocking portion spaced away from and beyond the jamming portion. The jamming portion has a triangle cross-section, with a point facing downwardly and away from the blocking portion. A second buckling element is extended upwards from the second die. The second buckling element has a gap at a top end thereof and passing through a side thereof. The gap defines a second contact surface, corresponding to the first contact surface, and an inclining surface, intersecting with the second contact surface with an acute angle formed therebetween for engaging with the jamming portion. When the first buckling element is buckled with the second buckling element, the first contact surface is engaged with the second contact surface, and the jamming portion received in a bottom of the gap is locked by the inclining surface for preventing the first contact surface from departing from the second contact surface.

As described above, since the jamming portion is buckled with the inclining surface, the first buckling element is engaged with the second buckling element firmly and tightly, without moving relatively in use. Thus the first contact surface can be attached to the second contact surface, which blocks the injection material to flow outside the mold, and prevents from producing burr on the molded component because of the interval resulted from the first contact surface separating from the second contact surface. Therefore, the mold structure for injection molding is not only simple and easy to manufacture, but also improves the peripheral precision of the molded components and increases the quality of the portable electronic devices.

### BRIEF DESCRIPTION OF THE DRAWINGS

The present invention will be apparent to those skilled in the art by reading the following description thereof, with reference to the attached drawings, in which:

FIG. 1 is a cross-sectional view of a mold structure for injection molding in prior art;

FIG. 2 is a partly enlarged view showing an enlarged A portion of FIG. 1;

FIG. 3 is a cross-sectional view showing a using state of the mold structure for injection molding shown in FIG. 1;

FIG. 4 is a partly enlarged view showing an enlarged B portion of FIG. 3;

FIG. 5 is a perspective view of a mold structure for injection molding of an embodiment in accordance with the present invention; and

FIG. 6 is a partly enlarged view showing an enlarged C portion of FIG. 5.

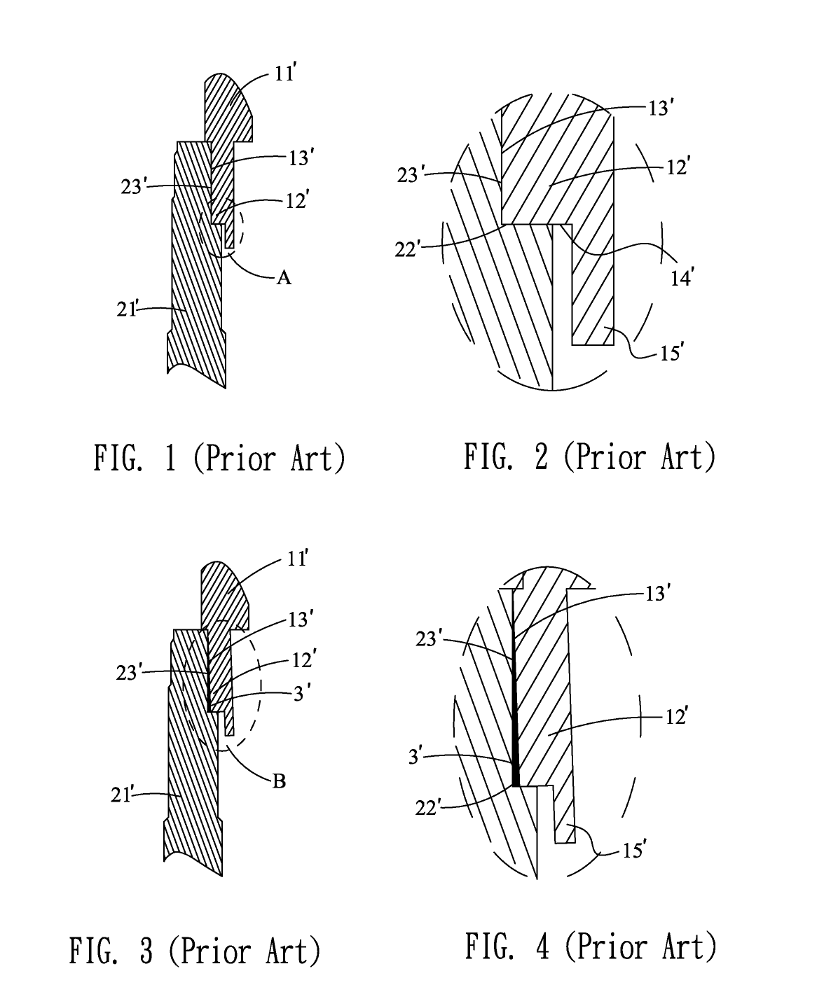

### DETAILED DESCRIPTION OF THE EMBODIMENT

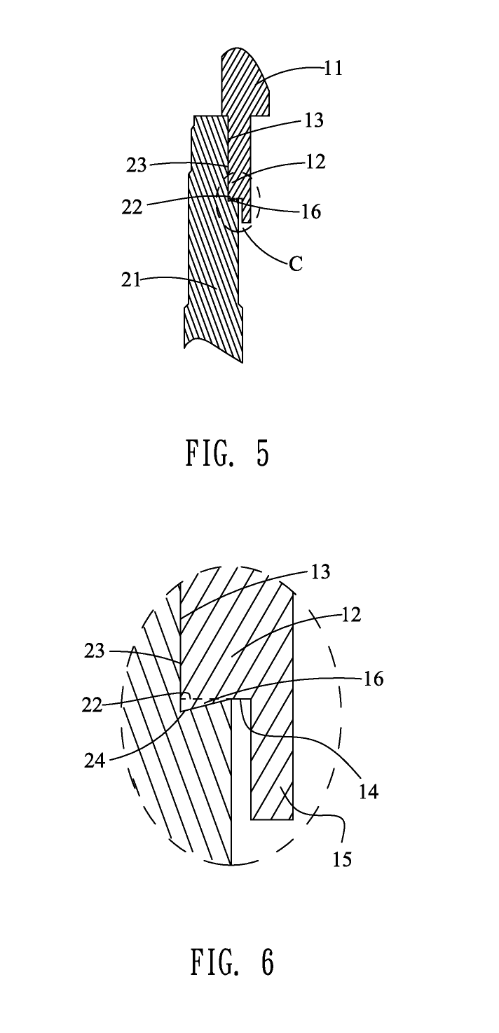

Referring to the drawings in greater detail, and first to FIGS. 5-6, the embodiment of the invention is shown in a mold structure for injection molding. The mold structure for injection molding comprises a first die (not shown), and a second die (not shown) disposed under and coupled with the first die. The first die has a first main body (not shown). The first main body has a protrusion 11. A bottom of the protrusion 11 is extended downwardly to form a first buckling element 12. The first buckling element 12 defines a first contact surface 13 extending upwards and downwards, and a bottom surface 14 perpendicular to the first contact surface 13. The bottom surface 14 has an end adjacent to the first contact surface 13 protruded downwards to form a jamming portion 16, and the other end protruded downwards to form a blocking portion 15. The jamming portion 16 has a triangle cross-section, with a point facing downwardly and away from the blocking portion 15. Herein, a surface of the jamming portion 16 opposite to the blocking portion 15 is substantially flush with the first contact surface 13. The blocking portion 15 is spaced away from the jamming portion 16 and stretches downwards with a predetermined distance.

The second die has a second main body (not shown). The second main body is protruded upwards to form a second buckling element 21 for holding the first buckling element 12 from downward to upward. The second buckling element 21 has a gap 22 at a top end thereof and passing through a side thereof. The gap 22 defines a second contact surface 23, corresponding to the first contact surface 13, and an inclining surface 24, intersecting with the second contact surface 23 with an acute angle for engaging with the jamming portion 16.

When the first buckling element 12 of the first die is engaged with the second buckling element 21 of the second die, the jamming portion 16 is laid in a bottom of the gap 22 and is locked by the inclining surface 24, and the first contact surface 13 is engaged with the second contact surface 23 tightly. The blocking portion 15 is spaced away from the second buckling element 21 with a predetermined distance for receiving the injection material therebetween. In the operation, the injection material is injected into a chamber formed between the blocking portion 15 and the second buckling element 21, forcing the first buckling element 12 and the second buckling element 21 opposite to each other. As the jamming portion 16 is locked by the inclining surface 24, the first buckling element 12 is able to engage with the second buckling element 21 firmly and tightly. Thereby, the first contact surface 13 can be attached to the second contact surface 23, without interval.

As described above, since the jamming portion 16 is buckled with the inclining surface 24, the first buckling element 12 is engaged with the second buckling element 21 firmly and tightly, without moving relatively in use. Thus the first contact surface 13 can be attached to the second contact surface 23, which blocks the injection material to flow outside the mold, and prevents from producing burr on the molded component because of the interval resulted from the first contact surface 13 separating from the second contact surface 23. Therefore, the mold structure for injection molding is not only simple and easy to manufacture, but also improves the peripheral precision of the molded components and increases the quality of the portable electronic devices.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A mold structure for injection molding having a first die, and a second die disposed under and holding the first die, comprising:
a first buckling element protruded downwardly from the first die, the first buckling element defining a first contact surface extending upwards and downwards, and a bottom surface perpendicular to the first contact surface, the bottom surface having an end adjacent to the first contact surface protruded downwards to form a jamming portion, and the other end protruded downwards to form a blocking portion spaced away from and beyond the jamming portion, the jamming portion having a triangle cross-section, with a point facing downwardly and away from the blocking portion; and
a second buckling element extended upwards from the second die, the second buckling element having a gap at a top end thereof and passing through a side thereof, the gap defining a second contact surface, corresponding to the first contact surface, and an inclining surface, intersecting with the second contact surface with an acute angle formed therebetween for engaging with the jamming portion,
wherein when the first buckling element is buckled with the second buckling element, the first contact surface is engaged with the second contact surface, and the jamming portion received in a bottom of the gap is locked by the inclining surface for preventing the first contact surface from departing from the second contact surface.

2. The mold structure for injection molding as claimed in claim 1, wherein a surface of the jamming portion opposite to the blocking portion is substantially flush with the first contact surface.
